(19) United States
(12) Patent Application Publication
(10) Pub. No.: US 2010/0165612 A1
(43) Pub. Date: Jul. 1, 2010

(54) Flashlight

(76) Inventor: Hsueh-Chu Yeh, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/345,845

(22) Filed: Dec. 30, 2008

(51) Int. Cl. F21L 4/04; F21L 4/00

(52) U.S. Cl. 362/190; 362/202

(57) ABSTRACT

A flashlight has a barrel formed with retaining elements located at a front end and a rear end of the barrel, respectively, and spaced from an outer periphery of the barrel. The retaining elements have oppositely facing ends each formed with a lead-in section narrower than the corresponding retaining element. A clipping device having a recessed end is matable with the retaining element at either the front or rear end of the barrel under guidance of the corresponding lead-in section while a projection formed at an opposite end of the clipping device is engageable with a corresponding one of grooves on the barrel. The barrel is concavely formed with a coupling section adjacent to the front end for coupling with resilient claws of an installation seat. Thus, the flashlight can be clipped on a user's clothes or installed on an object so as to provide illumination in a desired direction.

### BACKGROUND OF THE INVENTION

1. Technical Field

The present invention relates to a flashlight and, more particularly, to a flashlight attachable to a piece of clothing or an object so as to project light in directions suitable for the applications of the flashlight.

2. Description of Related Art

Nowadays, flashlights are available in various configurations, a majority of which are intended to facilitate installation of the flashlights according to the desired light-projection angles. For example, U.S. Pat. No. 6,612,714, titled “Belt Clip and Mounting Receptable, as for a Flashlight” and issued on Sep. 2, 2003, discloses a clip attachable to a flashlight so as to form a flashlight assembly. Therein, the flashlight has a barrel inserted into a hollow cylindrical body of the clip. A setscrew passes through a hole in the hollow cylindrical body and bears tightly against a tapered neck of the flashlight to secure the clip in position to the flashlight. Thus, the flashlight assembly can be clipped on an object by means of a clipping arm extending from the hollow cylindrical body and provide illumination in a desired manner.

### BRIEF SUMMARY OF THE INVENTION

Based on the existing flashlight assemblies, the present invention provides a new flashlight configuration, whereby a flashlight is conveniently attachable to a piece of clothing or an object so as to project light in directions appropriate for the applications of the flashlight.

The first objective of the present invention is to provide a flashlight having a barrel formed with retaining elements which are located at a front end and a rear end of the barrel, respectively, and spaced from an outer periphery of the barrel. The retaining elements have oppositely facing ends each formed with a lead-in section narrower than the corresponding retaining element. Thus, a clipping device having an end formed with a recess can mate with the retaining element at either the front or rear end of the barrel of the flashlight under guidance of the corresponding lead-in section while a projection formed at a bottom of an opposite end of the clipping device is engageable with a corresponding one of grooves concavely formed on the barrel. The clipping device is attached to either the front or rear end of the barrel of the flashlight and then clipped on a user's clothes to secure the flashlight in place and allow the flashlight to provide illumination in a desired direction.

The second objective of the present invention is to provide a flashlight having a barrel concavely formed with a coupling section adjacent to a front end of the barrel for coupling with resilient claws extending upward from an installation seat. The installation seat is coupled with the flashlight and installed on an object, thus allowing the flashlight to provide illumination in a desired direction.

The third objective of the present invention is to provide a flashlight having a barrel formed with retaining elements which are located at a front end and a rear end of the barrel, respectively, and spaced from an outer periphery of the barrel, wherein the retaining element at either the front or rear end of the barrel is attachable with a string for hanging the flashlight on a user's body to facilitate use of the flashlight.

### BRIEF DESCRIPTION OF THE SEVERAL VIEWS OF THE DRAWINGS

The invention as well as a preferred mode of use, further objectives and advantages thereof will be best understood by referring to the following detailed description of illustrative embodiments in conjunction with the accompanying drawings, wherein:

FIG. 1 is an exploded, perspective view of a flashlight according to the present invention;

FIG. 2 is an assembled, perspective view of the flashlight according to the present invention;

FIG. 3 is a partial sectional view of the flashlight according to the present invention when assembled with a clipping device;

FIG. 4 is a sectional view taken along a line 40-40 in FIG. 3;

FIG. 5 is a side view of the flashlight with the clipping device according to the present invention in a first mode of use;

FIG. 6 is a schematic drawing showing an application of the flashlight with the clipping device according to the present invention in the first mode of use;

FIG. 7 is a side view of the flashlight with the clipping device according to the present invention in a second mode of use;

FIG. 8 is a schematic drawing showing an application of the flashlight with the clipping device according to the present invention in the second mode of use;

FIG. 9 is a perspective view of the flashlight according to the present invention when assembled with an installation seat;

FIG. 10 is a schematic drawing showing an application of the flashlight with the installation seat according to the present invention; and

FIG. 11 is a schematic drawing showing an application of the flashlight according to the present invention when attached with a string.

### DETAILED DESCRIPTION OF THE INVENTION

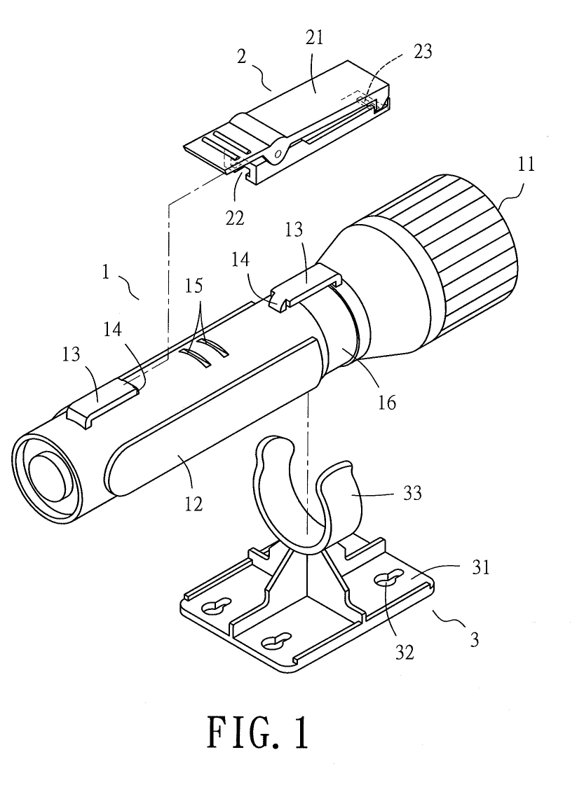

Referring to FIG. 1, a flashlight according to the present invention essentially comprises a flashlight 1, a clipping device 2, and an installation seat 3.

The flashlight 1 has one end formed as an illumination end 11 and an opposite end provided with a barrel 12. The barrel 12 of the flashlight 1 has a front end and a rear end each provided with a retaining element 13 spaced from an outer periphery of the barrel 12. The retaining elements 13 have ends which face each other oppositely and are each formed with a lead-in section 14 narrower than the corresponding retaining element 13. In addition, restricting grooves 15 are concavely provided at predetermined locations on the barrel 12 between the retaining elements 13. A coupling section 16 is concavely provided on the barrel 12 adjacent to the front end thereof.

The clipping device 2 is a clipping assembly including a resiliently clamping section 21 installed with a resilient element. The clipping device 2 has a lower end formed with an inwardly extending recess 22 (which is configured with an outer section and an inner section connected with and wider than the outer section so as to be inserted fittingly by the retaining element 13 and the relatively narrow lead-in section 14 formed therewith at either the front or rear end of the barrel 12 of the flashlight 1) and an opposite end having a bottom formed with a projection 23.

The installation seat 3 has a lower part formed as a positioning section 31 having a plurality of holes 32 for threaded fasteners to pass through, respectively, in order to secure the installation seat 3 in place. The installation seat 3 further has upwardly extending resilient claws 33.

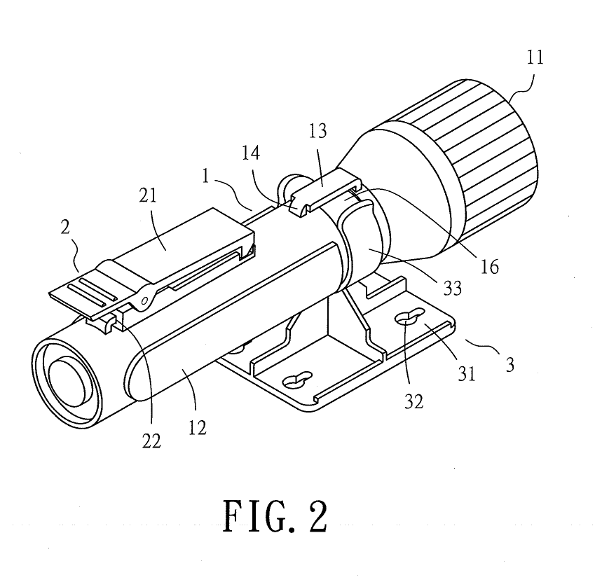

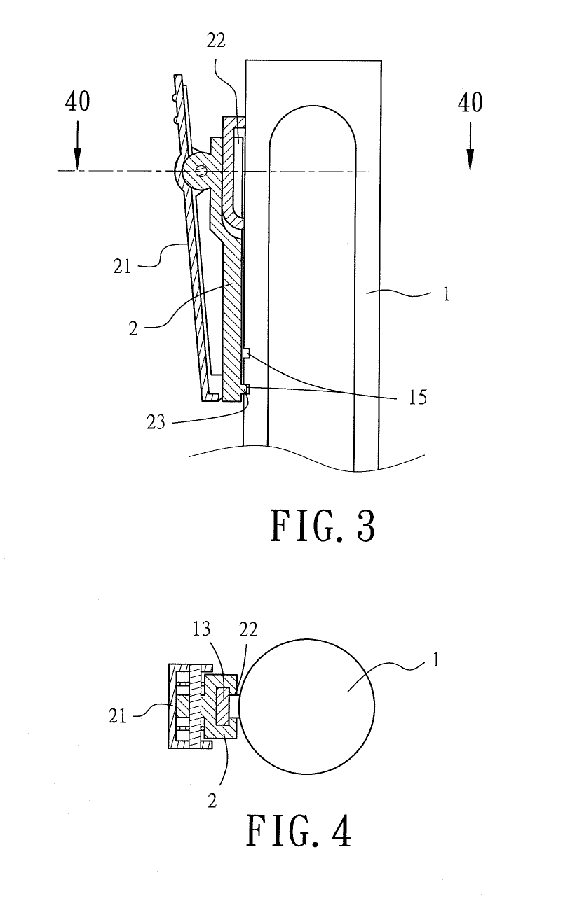

Referring to FIGS. 1 and 2, the flashlight 1, the clipping device 2, and the installation seat 3 are assembled in the following way. The recess 22 at the lower end of the clipping device 2 is mated with the retaining element 13 at either the front or rear end of the barrel 12 of the flashlight 1 under guidance of the corresponding lead-in section 14. (In the embodiment shown in FIGS. 1 and 2, the recess 22 is mated with the retaining element 13 at the rear end of the barrel 12.) Thus, the projection 23 at the bottom of the opposite end of the retaining device 2 is engaged with a corresponding one of the grooves 15 concavely provided on the barrel 12, as shown more clearly in FIGS. 3 and 4. The resilient claws 33 extending upward from the installation base 3 are fastened around the coupling section 16 adjacent to the front end of the barrel 12 of the flashlight 1, as shown in FIG. 2.

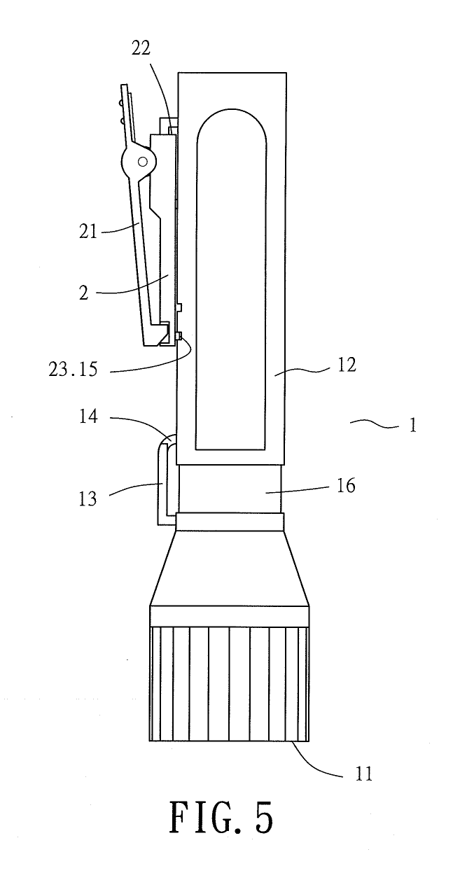

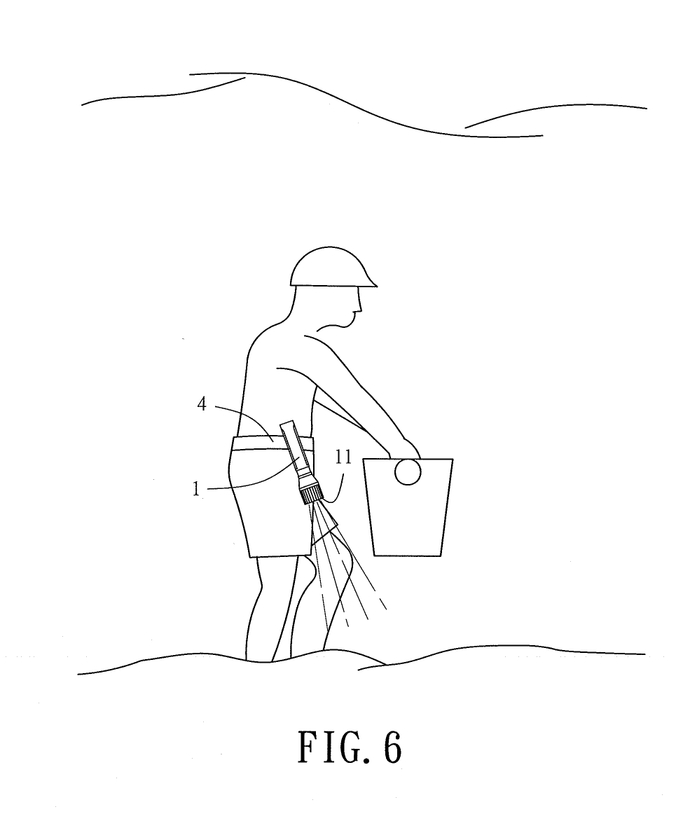

Referring to FIGS. 5 and 6, when the clipping device 2 is attached to the retaining element 13 at the rear end of the barrel 12 of the flashlight 1, the resiliently clamping section 21 of the clipping device 2 attached to the flashlight 1 can be conveniently clipped on a part 4 of a user's clothes around the waist, thereby securing the flashlight 1 in place and allowing the flashlight 1 to project light in a desired direction.

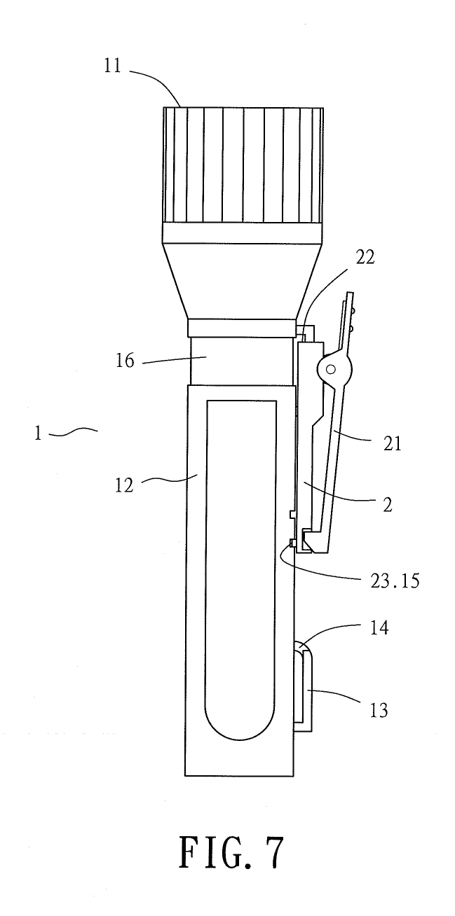

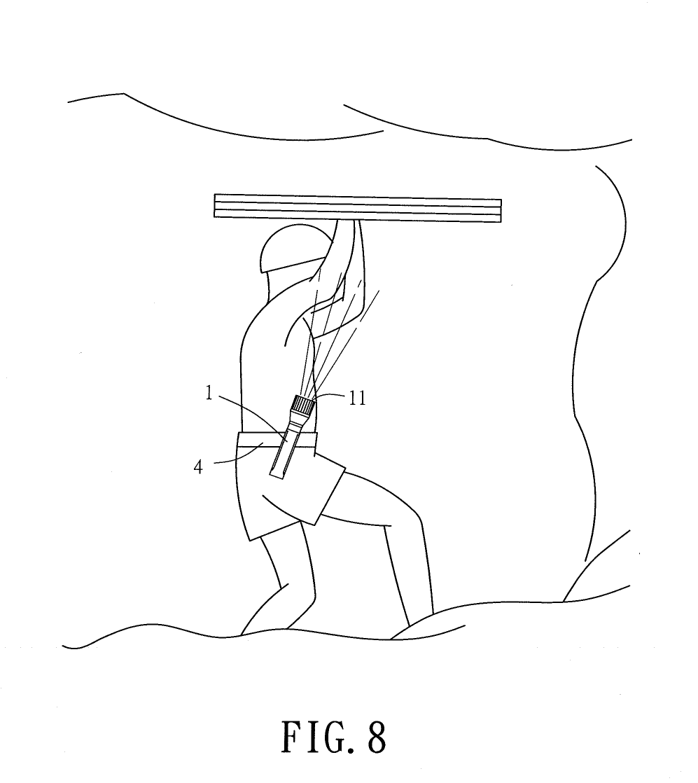

On the other hand, when the clipping device 2 is mated with the retaining element 13 at the front end of the barrel 12 of the flashlight 1, as shown in FIGS. 7 and 8, the resiliently clamping section 21 of the clipping device 2 connected to the flashlight 1 can be clipped on the part 4 of the user's clothes around the waist in a reverse direction so as to fix the flashlight 1 in position and allow the flashlight 1 to provide illumination in another desired direction.

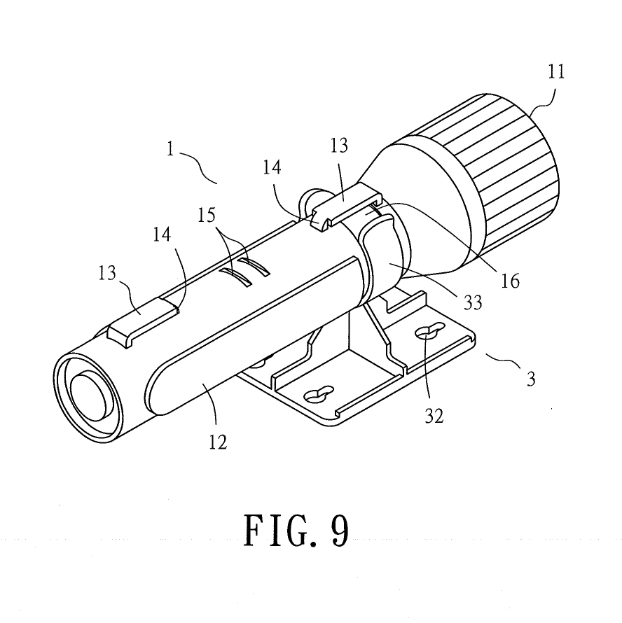

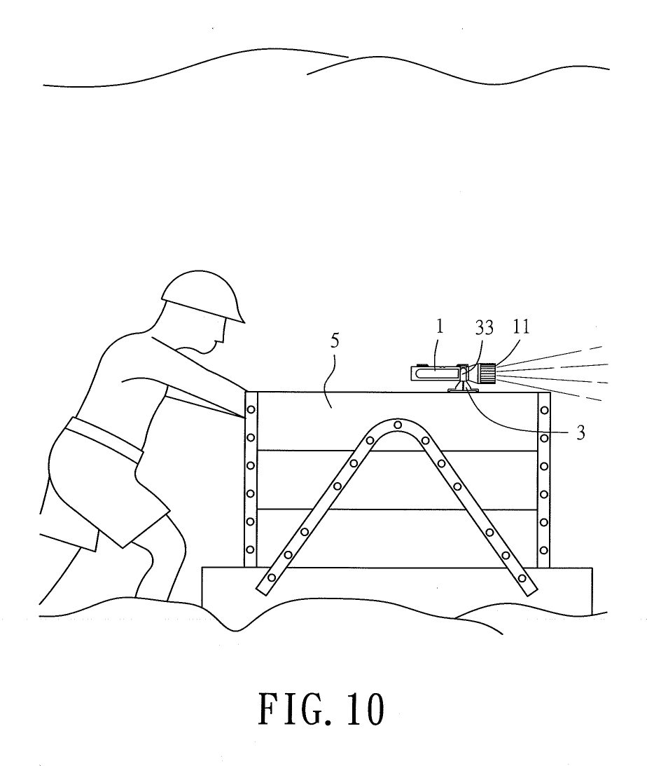

Referring to FIGS. 9 and 10, when the coupling section 16 of the barrel 12 of the flashlight 1 is coupled with the resilient claws 33 of the installation seat 3, the installation seat 3 coupled with the flashlight 1 can be easily secured in position on a desired object 5, allowing the flashlight 1 to provide illumination in an appropriate direction.

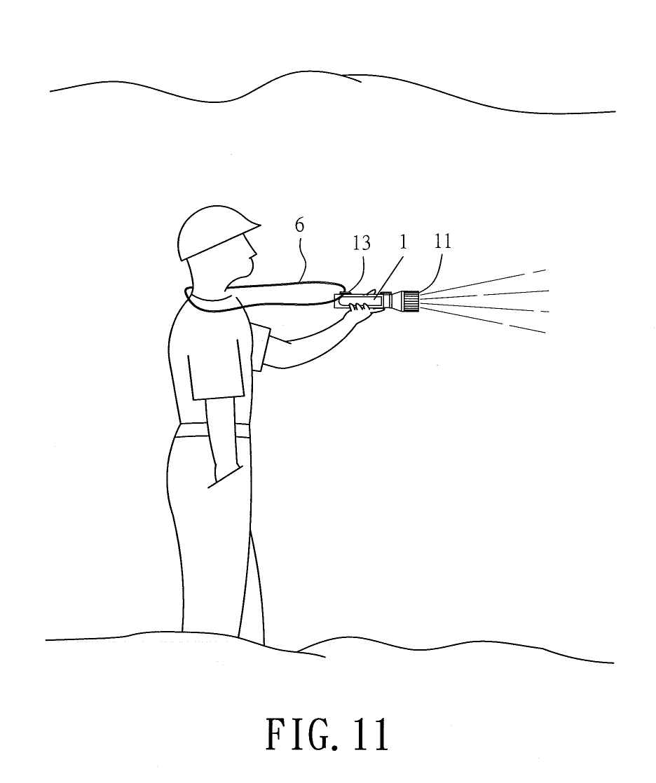

Besides, a string 6 can be attached to the retaining element 13 at either the front or rear end of the barrel 12 of the flashlight 1, as shown in FIG. 11, so that the flashlight 1 can be hung on the user's body and used for illumination whenever needed.

1. A flashlight, having an end formed as an illumination end and an opposite end provided with a barrel, the flashlight being characterized in that:
the barrel of the flashlight is formed with retaining elements which are located at a front end and a rear end of the barrel, respectively, and spaced from an outer periphery of the barrel, the retaining elements having oppositely facing ends each formed with a lead-in section narrower than each said retaining element, thereby allowing a recess formed at an end of a clipping device to mate with the retaining element at either the front or rear end of the barrel of the flashlight under guidance of a corresponding said lead-in section while a projection formed at a bottom of an opposite end of the clipping device is engaged with a corresponding one of grooves concavely formed on the barrel of the flashlight,
wherein the clipping device attached to the retaining element at either the front or rear end of the barrel of the flashlight is clipped on an external article to secure the flashlight in place and allow the flashlight to provide illumination in a desired direction.

2. The flashlight of claim 1, wherein either of the retaining elements located at the front and rear ends, and spaced from the outer periphery of the barrel of the flashlight is attached with a string for hanging the flashlight on an external article to facilitate use of the flashlight.

3. A flashlight, having an end formed as an illumination end and an opposite end provided with a barrel, the flashlight being characterized in that:
the barrel of the flashlight is concavely formed with a coupling section adjacent to a front end of the barrel, thereby allowing resilient claws extending upward from an installation seat to couple with the coupling section of the barrel of the flashlight,
wherein the installation seat attached to the flashlight is installed on an external article to allow the flashlight to provide illumination in a desired direction.
